(19) United States
(12) Patent Application Publication
(10) Pub. No.: US 2016/0204432 A1
(43) Pub. Date: Jul. 14, 2016

(54) NON-AQUEOUS ELECTROLYTE SECONDARY BATTERY AND METHOD FOR MANUFACTURING THE SAME

(71) Applicant: ISHIHARA SANGYO KAISHA, LTD., Osaka (JP)

(72) Inventors: Nobuharu Koshiba, Mie (JP); Yoshimasa Kumashiro, Mie (JP); Kazuhiro Akagawa, Mie (JP)

(73) Assignee: ISHIHARA SANGYO KAISHA, LTD., Osaka (JP)

(21) Appl. No.: 14/912,806

(22) PCT Filed: May 21, 2014
(86) PCT No.: PCT/JP2014/063485

§ 371 Date: Feb. 18, 2016

(30) Foreign Application Priority Data
Sep. 5, 2013 (JP) 2013-183742

(51) Int. Cl. H01M 4/48; H01M 4/485; H01M 10/0567; H01M 10/0569; H01M 10/0525; H01M 10/0568

(52) U.S. Cl. CPC H01M 4/483; H01M 10/0525; H01M 10/0568; H01M 10/0567; H01M 10/0569; H01M 4/485; H01M 2300/004; H01M 2004/027

(57) ABSTRACT

A non-aqueous electrolyte secondary battery includes: a positive electrode; a negative electrode that includes an active material containing a titanium oxide having a lithium ion storage potential of 1.2 V or higher (versus Li/Li⁺); a non-aqueous electrolyte containing a lithium salt including lithium hexafluorophosphate and lithium tetrafluoroborate; and a non-aqueous solvent including ethylene carbonate, cyclic carboxylic acid ester, or cyclic carbonate having four or more carbon atoms, and chain carbonate. The content of ethylene carbonate in the entire non-aqueous solvent is 5 to 20 vol %, and the concentration of lithium tetrafluoroborate in a non-aqueous electrolyte solution is 0.05 to 0.5 mol/l.

### TECHNICAL FIELD

The present invention relates to non-aqueous electrolyte secondary batteries and methods for manufacturing the same. More particularly, the present invention relates to a non-aqueous electrolyte secondary battery using a titanium oxide as a negative electrode active material, which reduces generation of gas associated with the use of the battery under high temperature environment and reduces capacity deterioration of the battery and which has excellent low-temperature charge and discharge properties, and a method for manufacturing the same.

### BACKGROUND ART

Non-aqueous electrolyte batteries that are charged and discharged by movement of lithium ions between negative and positive electrodes have been actively researched and developed as batteries with high energy density. Non-aqueous electrolyte batteries using a lithium-transition metal composite oxide as a positive electrode active material and using a carbon material as a negative electrode active material are currently available on the market and are frequently used in small mobile devices.

Recently, there have also been growing expectations for applications of medium- or large-sized non-aqueous electrolyte batteries as power supplies for power storage systems or as in-vehicle power supplies for HEVs etc. In such applications, the batteries are supposed to be used in a wider temperature range than that for consumer applications. In particular, the batteries for such applications are required to have sufficient charge and discharge properties even at low temperatures and are also required to be reliable at high temperatures.

In recent years, titanium oxides having a higher lithium ion storage/release potential than carbon materials have attracted attention as negative electrode active materials (e.g., Patent Literature 1). In titanium oxides having a lithium ion storage potential of 1.2 V or higher (versus Li/Li⁺), a metal lithium is essentially less likely to be deposited due to a significant difference between the lithium ion storage potential and a metal lithium deposition potential even if the battery is rapidly charged or is charged at a low temperature. For example, Li₄Ti₅O₁₂ is structurally degraded very slowly because its unit crystal lattice hardly changes with charge and discharge of the battery. Accordingly, batteries using a titanium oxide as a negative electrode active material are very safe and are expected to have excellent battery properties, especially excellent cycle life properties.

However, since such titanium oxides have a lithium ion storage/release potential as high as 1.2 V or higher (versus Li/Li⁺), a stable protective coating film called an SEI coating film is less likely to be formed on the surface, unlike the case of using a carbon active material. Accordingly, there are problems that a non-aqueous electrolyte solution is continuously reductively decomposed to generate gas. In particular, when the batteries are charged and discharged under high temperature environment (high temperature cycling), there are problems that gas tends to be generated and battery capacity is deteriorated. Generation of a large amount of gas may cause an increase in internal pressure or swelling of the batteries. Generation of a large amount of gas also accelerates capacity deterioration of the batteries and reduces life properties.

Various solutions using improved non-aqueous electrolyte solutions have been proposed to these problems. For example, Patent Literature 2 discloses a non-aqueous electrolyte secondary battery in which a positive electrode includes a lithium-containing nickel composite oxide, a negative electrode includes a lithium-containing titanium oxide, and a solvent of a non-aqueous electrolyte solution contains a specific ratio of cyclic carbonate ester and chain carbonate ester. Patent Literature 2 describes that cycle properties of the non-aqueous electrolyte secondary battery are improved as over discharge is reduced. However, in the case of using the electrolyte solution disclosed in Patent Literature 2, the non-aqueous electrolyte secondary battery does not have sufficient low-temperature charge and discharge properties, and generation of gas is not sufficiently reduced at the time a cycle test is performed at a high temperature.

Patent Literature 3 discloses a non-aqueous electrolyte secondary battery that comprises a positive electrode containing lithium manganese partially replaced with aluminum, a negative electrode containing lithium titanate, and a non-aqueous electrolyte solution containing a cyclic carbonate and a chain carbonate. In this non-aqueous electrolyte secondary battery, the content of the cyclic carbonate in a solvent of the non-aqueous electrolyte solution is 25 vol % or less. Patent Literature 3 describes that a non-aqueous electrolyte secondary battery is provided which exhibit excellent charge and discharge cycle properties in a wide temperature range from high to low temperatures. With the use of the electrolyte solution disclosed in Patent Literature 3, low-temperature properties are improved to some degree, and the non-aqueous electrolyte secondary battery exhibited excellent properties in a charge and discharge cycle test at 45° C. However, it has been found that a significant amount of gas is generated if the cycle test is carried out at a higher temperature like 55° C. or higher.

Patent Literature 4 discloses a non-aqueous electrolyte battery comprising a negative electrode having a negative electrode active material in which lithium ions are inserted and desorbed at a potential equal to or higher than 1.2 V. This non-aqueous electrolyte battery is characterized by satisfying 0≦a≦30, 0≦b<60, 0<c≦100, and 0≦d<10 at the same time, where the volume of carbonate ester with no carbon-carbon double bond contained in the non-aqueous solvent is 100, “a” represents the volume proportion of cyclic carbonate ester in the carbonate ester, “b” represents the volume proportion of dimethyl carbonate in the carbonate ester, “c” represents the volume proportion of ethyl methyl carbonate in the carbonate ester, and “d” represents the volume proportion of diethyl carbonate in the carbonate ester. Patent Literature 4 describes that a non-aqueous electrolyte battery is provided which exhibits excellent −30° C. low-temperature output properties and whose output properties are not reduced so much even by high temperature storage of the battery. However, in the case of using the electrolyte solution disclosed in Patent Literature 4, charge and discharge properties are still not sufficient at very low temperatures as low as −40° C., and generation of gas is not sufficiently reduced in a high temperature cycle test that is performed under harsher conditions than a test in which the non-aqueous electrolyte battery is left standing. Patent Literature 4 also describes that the use of cyclic carbonate ester for the high-potential negative electrode degrades various battery capabilities.

Various other non-aqueous electrolyte solutions have been proposed according to the active material to be used at the same time (e.g., Patent Literature 5 etc.). Even a non-aqueous electrolyte solution produced by combining a known solvent, a known electrolyte, a known additive, etc. can provide an unexpected advantageous effect due to the interaction of the components, depending on the combination. For example, the effect varies depending on the species of active materials to be used simultaneously due to the difference in lithium ion storage potentials, etc. It is therefore difficult even for those skilled in the art to speculate the effect.

### CITATION LIST

### Patent Literatures

Patent literature 1: JP 3502118B

Patent literature 2: WO98/057386

Patent literature 3: JP 2007-294164A

Patent literature 4: JP 2009-129632A

Patent literature 5: WO2004/012284

### SUMMARY OF INVENTION

### Technical Problem

It is an object of the present invention to provide a non-aqueous electrolyte secondary battery using a titanium oxide as a negative electrode active material, which reduces generation of gas associated with the use of the battery under high temperature environment, in particular, associated with repeated charge and discharge under high temperature environment (high temperature cycling) and reduces capacity deterioration of the battery, and which has excellent low-temperature charge and discharge properties.

### Solution to Problem

The inventors intensively studied solutions to the above problems. As a result, the inventors found that the above problems are solved by using a non-aqueous electrolyte with specific composition in a non-aqueous electrolyte battery comprising a negative electrode that includes an active material containing a titanium oxide having a lithium ion storage potential of 1.2 V or higher (versus Li/Li⁺). The inventors thus arrived at the present invention.

(1) That is, according to the present invention, a non-aqueous electrolyte secondary battery comprises a positive electrode, a negative electrode that includes an active material containing a titanium oxide having a lithium ion storage potential of 1.2 V or higher (versus Li/Li⁺), and a non-aqueous electrolyte solution containing a lithium salt and a non-aqueous solvent that dissolves the lithium salt therein. The non-aqueous solvent includes at least three solvents (a) to (c), namely (a) ethylene carbonate, (b) cyclic carboxylic acid ester, or cyclic carbonate having four or more carbon atoms, and (c) chain carbonate, the lithium salt includes at least lithium hexafluorophosphate and lithium tetrafluoroborate, a content of the ethylene carbonate in the entire non-aqueous solvent is 5 to 20 vol %, and a concentration of the lithium tetrafluoroborate in the non-aqueous electrolyte solution is 0.05 to 0.5 mol/l.

(2) In the non-aqueous electrolyte secondary battery according to (1), a content “a” (vol %) of the solvent (a) in the non-aqueous solvent and a content “b” (vol %) of the solvent (b) in the non-aqueous solvent satisfy b≧a.

(3) In the non-aqueous electrolyte secondary battery according to (1) or (2), the contents “a,” “b” and a content “c” (vol %) of the solvent (c) in the non-aqueous solvent satisfy (a+b)≦c.

(4) In the non-aqueous electrolyte secondary battery according to any one of (1) to (3), a molar concentration of the lithium hexafluorophosphate in the non-aqueous electrolyte solution is 0.5 to 1.4 mol/l.

(5) In the non-aqueous electrolyte secondary battery according to any one of (1) to (4), the solvent (b) includes cyclic carbonate or cyclic carboxylic acid ester having a melting point of −30° C. or less and a dielectric constant of 30 or more, and the solvent (c) includes chain carbonate having a melting point of −40° C. or less.

(6) In the non-aqueous electrolyte secondary battery according to any one of (1) to (5), the solvent (b) includes at least one selected from propylene carbonate, butylene carbonate, pentylene carbonate, γ-butyrolactone, and γ-valerolactone, and the solvent (c) includes at least one selected from ethyl methyl carbonate and diethyl carbonate.

(7) In the non-aqueous electrolyte secondary battery according to any one of (1) to (6), charge capacity of the non-aqueous electrolyte secondary battery is regulated by the negative electrode.

(8) In the non-aqueous electrolyte secondary battery according to any one of (1) to (7), the titanium oxide is selected from lithium titanate with a spinel structure, lithium titanate with a ramsdellite structure, a monoclinic titanic acid compound, a monoclinic titanium oxide, and lithium hydrogen titanate.

(9) In the non-aqueous electrolyte secondary battery according to any one of (1) to (8), the titanium oxide is selected from Li₄₊ₓTi₅O₁₂, Li₂₊ₓTi₃O₇, a titanic acid compound given by a general formula H₂TiₙO₂ₙ₊₁, and a bronze titanium oxide (where x is a real number that satisfies 0≦x≦3 and n is an even number of 4 or more).

(10) In the non-aqueous electrolyte secondary battery according to any one of (1) to (9), the non-aqueous electrolyte solution further contains at least one selected from a dinitrile compound, vinylene carbonate, ethylene sulfite, and 1,3-propanesultone.

(11) In the non-aqueous electrolyte secondary battery according to any one of (1) to (10), an active material of the positive electrode is lithium iron phosphate.

(12) According to the present invention, a method for manufacturing a non-aqueous electrolyte secondary battery comprises the steps of placing in a packaging member a positive electrode, a negative electrode that includes an active material containing a titanium oxide having a lithium ion storage potential of 1.2 V or higher (versus Li/Li⁺), and a non-aqueous electrolyte solution containing a lithium salt and a non-aqueous solvent that dissolves the lithium salt therein, and sealing an opening of the packaging member to produce a sealed secondary battery; and charging the sealed secondary battery. The non-aqueous solvent includes at least three solvents (a) to (c), namely (a) ethylene carbonate, (b) cyclic carboxylic acid ester, or cyclic carbonate having four or more carbon atoms, and (c) chain carbonate, the lithium salt includes at least lithium hexafluorophosphate and lithium tetrafluoroborate, a content of the ethylene carbonate in the entire non-aqueous solvent is 5 to 20 vol %, and a concentration of the lithium tetrafluoroborate in the non-aqueous electrolyte solution is 0.05 to 0.5 mol/l.

(13) According to the present invention, a method for manufacturing a non-aqueous electrolyte secondary battery comprises the steps of placing in a packaging member a positive electrode, a negative electrode that includes an active material containing a titanium oxide having a lithium ion storage potential of 1.2 V or higher (versus Li/Li⁺), and a non-aqueous electrolyte solution containing a lithium salt and a non-aqueous solvent that dissolves the lithium salt therein, and temporarily sealing an opening of the packaging member to produce a temporarily sealed secondary battery; adjusting a negative electrode potential of the temporarily sealed secondary battery to a potential higher than 0.8 V and equal to or lower than 1.4 V (versus Li/Li⁺) and storing the temporarily sealed secondary battery in an atmosphere of 50° C. or higher and lower than 80° C.; and opening the temporarily sealed secondary battery to discharge gas therefrom, and then finally sealing the packaging member. The non-aqueous solvent includes at least three solvents (a) to (c), namely (a) ethylene carbonate, (b) cyclic carboxylic acid ester, or cyclic carbonate having four or more carbon atoms, and (c) chain carbonate, the lithium salt includes at least lithium hexafluorophosphate and lithium tetrafluoroborate, a content of the ethylene carbonate in the entire non-aqueous solvent is 5 to 20 vol %, and a concentration of the lithium tetrafluoroborate in the non-aqueous electrolyte solution is 0.05 to 0.5 mol/l.

(14) In the method according to (13), the storage of the temporarily sealed secondary battery is performed in an open circuit.

### Advantageous Effects of Invention

According to the present invention, a non-aqueous electrolyte secondary battery using a titanium oxide as a negative electrode active material is provided which reduces generation of gas associated with the use of the battery under high temperature environment, in particular, associated with a high temperature cycling and reduces capacity deterioration of the battery, and which has excellent low-temperature charge and discharge properties.

### BRIEF DESCRIPTION OF DRAWINGS

FIG. 1 is a plan view showing a non-aqueous electrolyte secondary battery according to an embodiment of the present invention.

FIG. 2 is a sectional view showing the non-aqueous electrolyte secondary battery according to the embodiment of the present invention.

### DESCRIPTION OF EMBODIMENTS

A non-aqueous electrolyte secondary battery according to the present invention will be described in more detail below.

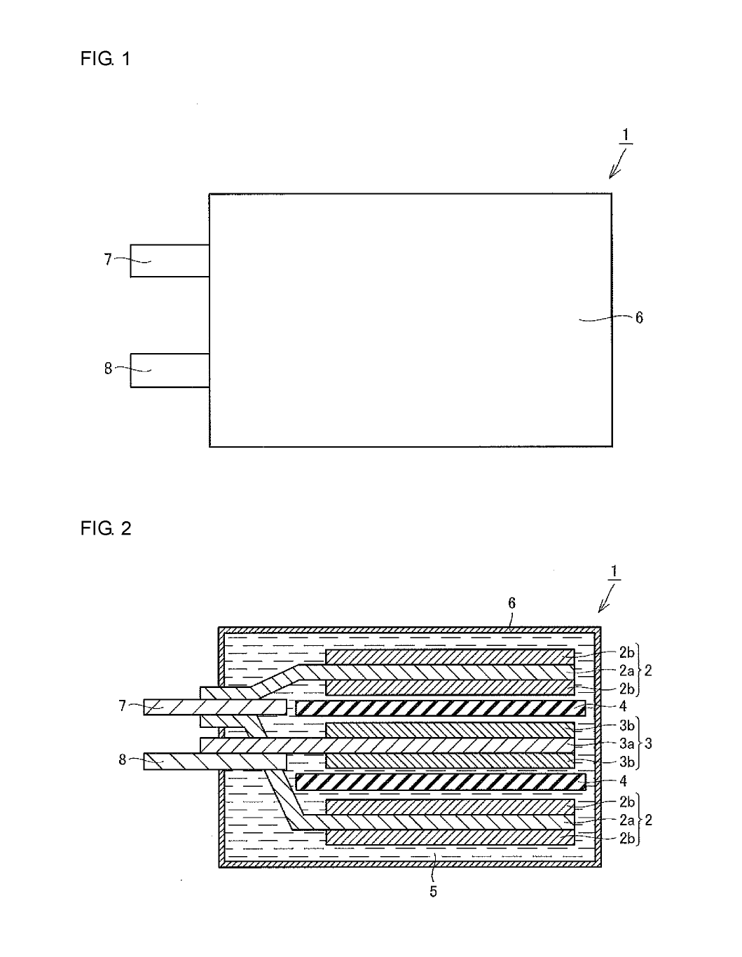

As shown in FIGS. 1 and 2, a non-aqueous electrolyte secondary battery 1 of the present invention has a positive electrode 2, a negative electrode 3, a separator 4, a non-aqueous electrolyte solution 5, and a packaging member 6.

The negative electrode 3 includes at least a negative electrode current collector 3a and a negative electrode active material layer 3b. The negative electrode active material layer is formed on one or both surfaces of the negative electrode current collector. The negative electrode active material layer contains at least a negative electrode active material and may contain a conductive material, a binder, or other material as necessary. For example, aluminum or an aluminum alloy, or copper or a copper alloy can be used for the negative electrode current collector.

A titanium oxide having a lithium ion storage potential of 1.2 V or higher (versus Li/Li⁺) is used as the negative electrode active material. Examples of such an active material include lithium titanate with a spinel structure (Li₄₊ₓTi₅O₁₂ (where x is a real number that satisfies 0≦x≦3), storage potential: 1.55 V versus Li/Li⁺), lithium titanate with a ramsdellite structure (Li₂₊ₓTi₃O₇ (where x is a real number that satisfies 0≦x≦3), storage potential: 1.6 V versus Li/Li⁺), a monoclinic titanium oxide, and lithium hydrogen titanate. Examples of the monoclinic titanium oxide include a monoclinic titanic acid compound given by the general formula H₂TiₙO₂ₙ₊₁ (where n is an even number of 4 or more, e.g., H₂Ti₁₂O₂₅, storage potential: 1.55 V versus Li/Li⁺), monoclinic lithium titanate given by the general formula Li₂TiₙO₂ₙ₊₁ (where n is an even number of 4 or more, e.g., Li₂Ti₁₈O₃₇ etc.), and bronze titanium oxide (TiO₂(B), storage potential: 1.6 V versus Li/Li⁺). An example of lithium hydrogen titanate includes the lithium titanate with a part of lithium elements replaced with hydrogen. For example, lithium hydrogen titanate is lithium hydrogen titanate given by the general formula HₓLi_{y-x}Ti_{z}O₄ (where x, y, and z are real numbers that satisfy y≧x<0, 0.8≦y≦2.7, and 1.3≦z≦2.2, e.g., HₐLi_{4/3-a}Ti_{5/3}O₄, where a is a real number that satisfies 0<a<4/3) or lithium hydrogen titanate given by the general formula H₂₋ₓLiₓTiₙO₂ₙ₊₁ (where n is an even number of 4 or more, and x is a real number that satisfies 0<x<2, e.g., H₂₋ₓLiₓTi₁₂O₂₅). In these chemical formulas, a part of lithium, titanium, and oxygen may be replaced with other element(s), and these titanium oxides may be titanium oxides with stoichiometric compositions. These titanium oxides are not limited to the titanium oxides with stoichiometric compositions, or may be titanium oxides with non-stoichiometric compositions having a deficit or excess of a part of elements. One of these titanium oxides may be used alone, or a mixture of two or more of the titanium oxides may be used. Alternatively, a titanium oxide (e.g., TiO₂) that changes to a lithium titanium composite oxide by charge and discharge may be used as an active material. These materials may be mixed as desired. The upper limit of the lithium ion storage potential of the titanium oxide is preferably, but not limited to, 2 V. Although the negative electrode may include a known negative electrode active material other than the titanium oxide, the capacity of the titanium oxide preferably accounts for 50% or more of the negative electrode capacity, and more preferably 80% or more of the negative electrode capacity.

It is preferable to use as the titanium oxide a titanium oxide selected from Li₄₊ₓTi₅O₁₂, Li₂₊ₓTi₃O₇, the titanic acid compound given by the general formula H₂TiₙO₂ₙ₊₁, and the bronze titanium oxide because the dinitrile compound tends to work effectively. In these chemical formulas, x is a real number that satisfies 0≦x≦3, and n is an even number of 4 or more.

As used herein, the “lithium ion storage potential (versus Li/Li⁺)” refers to a potential corresponding to the midpoint of capacity in a potential-capacity curve for charging. This potential-capacity curve is obtained by capacity measurement in which a coin cell using lithium metal foil as a counter electrode is charged with a constant current at 0.25 C in a 25° C. environment until the cell voltage reaches 1.0 V and is then discharged with a constant current at 0.25 C in the 25° C. environment until the cell voltage reaches 3.0 V.

It is preferable that the titanium oxide have an average primary particle size of 2 μm or less. The titanium oxide having an average primary particle size of 2 μm or less has a sufficient effective area that contributes to an electrode reaction, and thus provides satisfactory large current discharge properties. The average primary particle size can be obtained as an average of the major axes of 100 primary particles measured with an electron scanning microscope. The primary particles may be granulated using a known method to form secondary particles. It is preferable that the average secondary particle size be 0.1 to 30 μm. The average secondary particle size can be measured by a laser diffraction/scattering method.

It is preferable that the titanium oxide have a specific surface area of 1 to 20 m²/g. The titanium oxide having a specific surface area of 1 m²/g or more has a sufficient effective area that contributes to an electrode reaction, and thus provides satisfactory large charge and discharge properties. Even the titanium oxide having a specific surface area of over 20 m²/g can provide the effect of the present invention. However, the use of the titanium oxide having a specific surface area of over 20 m²/g may cause problems in terms of handling in manufacturing of the electrode, such as in terms of dispersion properties of the active material in negative electrode composite slurry, coating properties of the current collector with the composite slurry, and adhesion properties between the active material layer and the current collector. It is therefore preferable to use the titanium oxide having a specific surface area of 20 m²/g or less. In the case of using the titanium oxide having a specific surface area as large as 5 m²/g or more, a large amount of gas is generated in a charge/discharge cycle or during storage of the battery. However, the use of the present invention reduces generation of gas, and in particular, significantly reduces generation of gas associated with a high temperature cycling. As a result, the titanium oxide having a large surface area can be used as the negative electrode active material, whereby a non-aqueous electrolyte secondary battery having satisfactory low-temperature charge and discharge properties and large current charge and discharge properties is obtained. The specific surface area can be obtained by a single-point BET method using nitrogen adsorption.

The conductive material is used to make the negative electrode conductive. Any conductive material that does not cause a chemical change in a battery to be configured may be used as the conductive material. Examples of such a conductive material include conductive materials containing a carbon material like natural graphite, artificial graphite, carbon black, acetylene black, ketjen black, or carbon fibers, a metal material like metal powder or metal fibers such as copper, nickel, aluminum, or silver, a conductive polymer such as a polyphenylene derivative, or a mixture thereof.

For example, polytetrafluoroethylene (PTFE), polyvinylidene fluoride (PVdF), fluororubber, styrene-butadiene rubber (SBR), carboxymethyl cellulose (CMC), etc. can be used as the binder.

Other materials that can be contained in the negative electrode active material layer include various known additives.

It is preferable that the negative electrode active material layer contain 70 to 95 mass % of the negative electrode active material, 0 to 25 mass % of the conductive material, and 2 to 10 mass % of the binder.

The negative electrode can be produced by suspending the negative electrode active material, the conductive material, and the binder in an appropriate solvent to prepare slurry, coating one or both surfaces of the current collector with the slurry, and drying the coating.

A liquid non-aqueous electrolyte (non-aqueous electrolyte solution) that is prepared by dissolving a lithium salt in a non-aqueous solvent is used as the non-aqueous electrolyte solution. This non-aqueous electrolyte solution contains at least three solvents, namely (a) ethylene carbonate, (b) cyclic carboxylic acid ester, or cyclic carbonate having four or more carbon atoms, and (c) chain carbonate, as non-aqueous solvents and contains at least lithium hexafluorophosphate and lithium tetrafluoroborate as lithium salts. In this non-aqueous electrolyte solution, the content of (a) ethylene carbonate in the entire non-aqueous solvent is 5 to 20 vol %, and the concentration of lithium tetrafluoroborate in the non-aqueous electrolyte solution is 0.05 to 0.5 mol/l.

In the case of using the non-aqueous electrolyte solution containing specific amounts of ethylene carbonate and lithium tetrafluoroborate, a coating film corresponding to SEI would be formed on the surface of the negative electrode even when a titanium oxide having a high potential is used as a negative electrode active material. Although formation of this coating film is an unexpected effect, this coating film has excellent lithium ion conductivity and is highly stable. This coating film thus prevents direct contact between the titanium oxide and the electrolyte solution components and inhibits electron transfer from the titanium oxide to the electrolyte solution components, thereby reducing decomposition of the electrolyte solution component and reducing generation of gas. The electrolyte solution containing at least five components according to the present invention would have sufficient lithium ion conductivity even in a low temperature range, and the battery using this electrolyte solution would exhibit excellent low-temperature charge and discharge properties. This inference does not limit the present invention.

A known cyclic carboxylic acid ester solvent can be used as the cyclic carboxylic acid ester. Examples of the cyclic carboxylic acid ester include γ-butyrolactone (GBL), decanolide, valerolactone, mevalonolactone, and caprolactone.

A cyclic carbonate given by the following structural formula can be used as the cyclic carbonate having four or more carbon atoms. In the structural formula, X represents a hydrocarbon group. In particular, X is preferably an alkyl group having one to three carbon atoms. Examples of such a material include propylene carbonate, butylene carbonate, and pentylene carbonate.

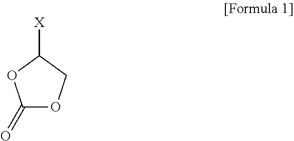

A known chain carbonate solvent can be used as the chain carbonate. The chain carbonate is preferably a chain carbonate given by CₙH₂ₙ₊₁(COO)CₘH₂ₘ₊₁ (where m and n are integers of 1 to 3). Specific examples of the chain carbonate include ethyl methyl carbonate and diethyl carbonate.

The content of ethylene carbonate in the entire non-aqueous solvent of the non-aqueous electrolyte solution is 5 to 20 vol %, and the concentration of lithium tetrafluoroborate in the non-aqueous electrolyte solution is 0.05 to 0.5 mol/l. It is preferable that the mass ratio (LiBF₄/EC) of lithium tetrafluoroborate (LiBF₄) to ethylene carbonate (EC) be 0.015 or higher and lower than 0.72 in the above content range. In this case, lithium tetrafluoroborate and ethylene carbonate would together react on the surface of the titanium oxide to form a coating film with an appropriate thickness on the surface of the negative electrode, as described above. This coating film has high lithium ion conductivity and is stably present in a wide temperature range. A non-aqueous electrolyte secondary battery having further improved high-temperature cycle properties and low-temperature charge and discharge properties is thus obtained. It is more preferable that the mass ratio (LiBF_{4/}EC) be 0.03 to 0.15.

If the content of ethylene carbonate is too low, the effect of the present invention is not sufficiently obtained in a high temperature cycling. Namely, generation of gas is not sufficiently reduced in a high temperature cycling. If the content of ethylene carbonate is too high, gas tends to be generated, and the low-temperature charge and discharge properties are degraded. Such degradation in low-temperature charge and discharge properties occurs probably because a coating film is excessively formed on the surface of the negative electrode and the excessive formation of the coating film accelerates reduction in capacity retention in a high temperature cycling and reduces lithium ion conductivity of the electrolyte solution at low temperatures. If the content of lithium tetrafluoroborate is too low, the effect of the present invention not sufficiently obtained in a high temperature cycling. Namely, generation of gas is not sufficiently reduced in a high temperature cycling. This is probably because the coating film on the surface of the negative electrode becomes less stable. If the content of lithium tetrafluoroborate is too high, the low-temperature charge and discharge properties are degraded. This is probably because a coating film is excessively formed on the surface of the negative electrode and the excessive formation of the coating film accelerates reduction in capacity retention in a high temperature cycling and reduces lithium ion conductivity of the electrolyte solution at low temperatures. The content of ethylene carbonate in the entire non-aqueous solvent is preferably 5 to 20 vol %, and more preferably 5 to 10 vol %. The concentration of lithium tetrafluoroborate in the non-aqueous electrolyte solution is preferably 0.05 to 0.5 mol/l, more preferably 0.05 to 0.3 mol/l, and more preferably 0.05 to 0.2 mol/l.

Both lithium tetrafluoroborate and ethylene carbonate would be consumed as a coating film is formed on the surface of the negative electrode. The concentrations of lithium tetrafluoroborate and ethylene carbonate in the electrolyte solution should therefore gradually decrease after assembly of the battery. The electrolyte solution used in the present invention need only satisfy the above composition at least at the time of assembly of the battery. Lithium tetrafluoroborate and ethylene carbonate eventually may not be contained in the electrolyte solution as a result of use of the battery after assembly. The problems described above tend to occur if large amounts of lithium tetrafluoroborate and ethylene carbonate remain in the electrolyte solution after production of the battery. It is preferable to reduce the residual amounts of lithium tetrafluoroborate and ethylene carbonate in the electrolyte solution to such an extent that the disadvantages do not arise significantly.

It is preferable that the content “a” (vol %) of (a) ethylene carbonate and the content “b” (vol %) of (b) cyclic carboxylic acid ester or cyclic carbonate having four or more carbon atoms in the non-aqueous solvent satisfy b≧a. This increases lithium ion conductivity of the electrolyte solution at low temperatures and further improves low-temperature charge and discharge properties. The ratio b/a is preferably 1 to 9, and more preferably 3 to 7.

It is preferable that the contents “a,” “b” and the content “c” (vol %) of (c) chain carbonate in the non-aqueous solvent satisfy (a+b)≦c. This maintains high lithium ion conductivity of the electrolyte solution even in a very low temperature range and further improves low-temperature charge and discharge properties. The ratio c/(a+b) is preferably 1 to 9, more preferably 1 or more and less than 3, and more preferably 1.5 to 2.4.

It is preferable that the molar concentration of lithium hexafluorophosphate in the non-aqueous electrolyte solution be 0.5 to 1.4 mol/l. This reduces the rate of decrease in capacity retention associated with a high temperature cycling and maintains high lithium ion conductivity of the electrolyte solution, and thus further improves low-temperature charge and discharge properties. The molar concentration of lithium hexafluorophosphate is more preferably 0.8 to 1.4.

The lithium salts in the non-aqueous electrolyte solution may be only lithium hexafluorophosphate and lithium tetrafluoroborate, or the non-aqueous electrolyte solution may further contain any of other lithium salts. Examples of other lithium salts include lithium hexafluoroarsenate (LiAsF₆), lithium perchlorate (LiClO₄), lithium bis(trifluoromethanesulfonyl)imide (LiN(CF₃SO₂)₂, LiTSFI), and lithium trifluoromethanesulfonate (LiCF₃SO₃). The non-aqueous electrolyte solution may additionally contain one or more of these lithium salts.

It is preferable that the concentration of the lithium salt in the non-aqueous solvent be 0.7 to 1.5 mol/l. The concentration of 0.7 mol/l or more reduces lithium ion conduction resistance of the electrolyte solution and improves charge and discharge properties. The concentration of 1.5 mol/l or less reduces an increase in melting point or viscosity of the electrolyte solution and allows the electrolyte to be in a liquid form at normal temperature. It is particularly preferable that the concentration of the lithium salt in the non-aqueous solvent be 0.85 to 1.45 mol/l.

It is preferable that the non-aqueous electrolyte solution contain cyclic carbonate or cyclic carboxylic acid ester having a melting point of −30° C. or less and a dielectric constant of 30 or more as the solvent (b), and chain carbonate having a melting point of −40° C. or less as the solvent (c). Selecting such solvent species produces an electrolyte solution having excellent lithium ion conductivity even at low temperatures. For example, the melting point and the dielectric constant may be obtained by referring to “Lithium Ion Secondary Batteries: Materials and Applications” (Masaki YOSHIO, Nikkan Kogyo Shinbun Ltd., 1996). Those melting points and dielectric constants that are not shown therein are obtained by an alternating current impedance method. It is more preferable to use the solvent (c) having viscosity of 0.5 to 0.8 mPa·s because it increases mobility of lithium ions. Viscosity is measured at 20° C. by using an E type rotational viscometer according to JIS K 7117-2.

An example of such a solvent (b) is at least one selected from propylene carbonate (mp: −49° C., εᵣ: 65), butylene carbonate (mp: −53° C., εᵣ: 53), pentylene carbonate (mp: −45° C., εᵣ: 46), γ-butyrolactone (mp: −44° C., εᵣ: 39), and γ-valerolactone (mp: −31° C., εᵣ: 34). An example of such a solvent (c) is at least one selected from ethyl methyl carbonate (mp: −53° C., η₀: 0.65 mPa·s) and diethyl carbonate (mp: −43° C., η₀: 0.75 mPa·s). As used herein, mp represents a melting point, εᵣ represents a dielectric constant, and η₀ represents viscosity.

The non-aqueous solvent in the non-aqueous electrolyte solution may include a non-aqueous organic solvent other than the above solvents (a) to (c). Examples of such a non-aqueous organic solvent include an ester solvent, an ether solvent, a ketone solvent, an alcohol solvent, and an aprotic solvent. It is preferable that the content of such a solvent in the entire non-aqueous solvent be 20 vol % or less.

Methyl acetate, ethyl acetate, n-propyl acetate, dimethyl acetate, methyl propionate, ethyl propionate, etc. can be used as the ester solvent.

Dibutyl ether, tetraglyme, diglyme, dimethoxyethane, 2-methyltetrahydrofuran, tetrahydrofuran, etc. can be used as the ether solvent.

Cyclohexanone etc. can be used as the ketone solvent.

Ethyl alcohol, isopropyl alcohol, etc. can be used as the alcohol solvent.

Nitriles such as R—CN (where R represents a C2 to C20 linear, branched, or cyclic hydrocarbon group, and may include a double bond, an aromatic ring, or an ether bond), amides such as dimethylformamide, dioxolanes such as 1,3-dioxolane, sulfolanes, etc. can be used as the aprotic solvent.

The electrolyte solution may further contain an additive that improves low-temperature properties etc. of the lithium battery. For example, a dinitrile compound, a carbonate material, ethylene sulfite (ES), or 1,3-propanesultone (PS) can be used as the additive.

For example, the dinitrile compound may be any organic dinitrile compound. In particular, a dinitrile compound, namely a chain saturated hydrocarbon compound having nitrile groups bonded to both terminals thereof, which is given by the structural formula NC—(CH₂)ₙ—CN (where n≧1 and n is an integer), is preferable as this dinitrile compound easily dissolves in the electrolyte solution. In particular, in view of availability and cost, any of dinitrile compounds of n=about 1 to 10, namely any of malononitrile (n=1), succinonitrile (n=2), glutaronitrile (n=3), adiponitrile (n=4), pimelonitrile (n=5), suberonitrile (n=6), azelanitrile (n=7), sebaconitrile (n=8), undecanenitrile (n=9), and dodecanenitrile (n=10), is preferred, and malononitrile, succinonitrile, glutaronitrile, or adiponitrile is particularly preferred.

For example, the carbonate material may be selected from the group consisting of vinylene carbonate (VC), a vinylene carbonate derivative having one or more substituents selected from the group consisting of a halogen (e.g., —F, —Cl, —Br, —I, etc.), a cyano group (—CN), and a nitro group (—NO₂), and an ethylene carbonate derivative having one or more substituents selected from the group consisting of a halogen (e.g., —F, —Cl, —Br, —I, etc.), a cyano group (—CN), and a nitro group (—NO₂).

Either one material or two or more materials may be used as the additive. Specifically, the electrolyte solution may further contain one or more additives selected from the group consisting of succinonitrile (SCM, vinylene carbonate (VC), fluoroethylene carbonate (FEC), ethylene sulfite (ES), and 1,3-propanesultone (PS). These materials should serve to form a more stable coating film on the titanium oxide of the negative electrode when used in combination with the solvent and the lithium salt of the present invention. This further enhances the effect of the present invention, namely further reduces generation of gas under high temperature environment.

In the case where the electrolyte solution contains the additive, it is preferable that the content of the additive be 10 parts by mass or less, and more preferably 0.1 to 10 parts by mass, per 100 parts by mass of the total amount of the non-aqueous organic solvent and the lithium salt. This content range improves properties of the battery under high temperature environment. The content of the additive is more preferably 1 to 5 parts by mass.

A known method can be used to measure the kinds and concentrations of solvent and lithium salt in the electrolyte solution. For example, gas chromatography mass spectroscopy can be used to analyze the solvent, and NMR can be used to analyze the solvent and the lithium salt.

As shown in FIG. 2, the positive electrode 2 includes at least a positive electrode current collector 2a and a positive electrode active material layer 2b. The positive electrode active material layer is formed on one or both surfaces of the positive electrode current collector. The positive electrode active material layer contains at least a positive electrode active material and may contain a conductive material, a binder, or other material as necessary. For example, aluminum or an aluminum alloy can be used for the positive electrode current collector.

A known electrode active material that can function as a positive electrode for the titanium oxide used as a negative electrode active material may be used as the positive electrode active material. Specifically, any electrode active material having a lithium ion storage potential of 1.6 V or higher (versus Li/Li⁺), and more preferably 2.0 V or higher (versus Li/Li⁺), may be used as the positive electrode active material. Various oxides and sulfides can be used as such an active material. Examples of such oxides and sulfides include manganese dioxide (MnO₂), iron oxide, copper oxide, nickel oxide, a lithium manganese composite oxide (e.g., LiₓMn₂O₄ or LiₓMnO₂), a lithium nickel composite oxide (e.g., LiₓNiO₂), a lithium cobalt composite oxide (LiₓCoO₂), a lithium nickel cobalt composite oxide (e.g., LiₓNi_{1-y}Co_{y}O₂), a lithium manganese cobalt composite oxide (LiₓMn_{y}Co_{1-y}O₂), a lithium nickel manganese cobalt composite oxide (LiₓNi_{y}Mn_{z}Co_{1-y-z}O₂), a lithium manganese nickel composite oxide with a spinel structure (LiₓMn_{2-y}Ni_{y}O₄), a lithium phosphorus oxide with an olivine structure (LiₓFePO₄, LiₓFe_{1-y}Mn_{y}PO₄, LiₓCoPO₄, LiₓMnPO₄, etc.) a lithium silicon oxide (Li₂ₓFeSiO₄, etc.), iron sulfate (Fe₂(SO₄)₃), vanadium oxide (e.g., V₂O₅), and a solid solution composite oxide given by xLi₂MO₃.(1−x)LiM′O₂ (where M and M′ represent one or more metals of the same or different kinds). These materials may be mixed as desired. In the above chemical formulas, it is preferable that x, y, and z be in the range of 0 to 1.

Organic and inorganic materials such as a conductive polymer material like polyaniline and polypyrrole, a disulfide polymer material, sulfur (S), and fluorocarbon, etc. may be used as the positive electrode active material.

Among the above positive electrode active materials, it is preferable to use an active material having a high lithium ion storage potential. For example, a lithium manganese composite oxide with a spinel structure (LiₓMn₂O₄), a lithium nickel composite oxide (LiₓNiO₂), a lithium cobalt composite oxide (LiₓCoO₂), a lithium nickel cobalt composite oxide (LiₓNi_{1-y}Co_{y}O₂), a lithium manganese cobalt composite oxide (LiₓMn_{y}Co_{1-y}O₂), a lithium nickel manganese cobalt composite oxide (LiₓNi_{y}Mn_{z}Co_{1-y-z}O₂), a lithium manganese nickel composite oxide with a spinel structure (LiₓMn_{2-y}Ni_{y}O₄), lithium iron phosphate (LiₓFePO₄), etc. are preferably used, and in particular, a lithium nickel manganese cobalt composite oxide and lithium iron phosphate are preferably used. In the above chemical formulas, it is preferable that x, y, and z be in the range of 0 to 1.

For example, acetylene black, carbon black, graphite, etc. can be used as the conductive material.

For example, polytetrafluoroethylene (PTFE), polyvinylidene fluoride (PVdF), fluororubber, styrene-butadiene rubber (SBR), carboxymethyl cellulose (CMC), etc. can be used as the binder.

Other materials that can be contained in the positive electrode active material layer include various additives. For example, a dinitrile compound, fluoroethylene carbonate, vinylene carbonate, 1,3-propanesultone, ethylene sulfite, etc. can be used.

It is preferable that the positive electrode active material layer contain 80 to 95 mass % of the positive electrode active material, 3 to 18 mass % of the conductive material, and 2 to 10 mass % of the binder.

The positive electrode can be produced by suspending the positive electrode active material, the conductive material, and the binder in an appropriate solvent to prepare slurry, coating one or both surfaces of the current collector with the slurry, and drying the coating.

The separator is placed between the positive electrode and the negative electrode to prevent the positive and negative electrodes from contacting each other. The separator is made of an insulating material. The separator is shaped so as to allow an electrolyte to move between the positive and negative electrodes.

Examples of the separator include a synthetic resin nonwoven fabric, a porous polyethylene film, a porous polypropylene film, and a cellulose-based separator.

The packaging member may be a laminated film or a metal container. A multilayer film made of metal foil covered with a resin film is used as the laminated film. A resin for the resin film may be a polymer such as polypropylene (PP), polyethylene (PE), nylon, or polyethylene terephthalate (PET). The inner surface of the packaging member made of the laminated film is comprised of a thermoplastic resin such as PP or PE.

It is preferable that the laminated film have a thickness of 0.2 mm or less.

The non-aqueous electrolyte secondary battery of the present invention may be configured so that charging of the battery is regulated by the negative electrode. With this configuration, a non-aqueous electrolyte secondary battery is provided which further reduces generation of gas associated with a high temperature cycling and further reduces capacity deterioration of the battery and which has further improved low-temperature charge and discharge properties.

In order to prevent deposition of the metal lithium during charging of the battery, in conventional non-aqueous electrolyte batteries using a negative electrode active material having a low lithium ion storage potential such as a carbon material, the negative electrode is made to have larger capacity than the positive electrode so that the capacity of the battery is regulated by the positive electrode. On the other hand, in the case where the ratio of the negative electrode capacity to the positive electrode capacity is set so that the capacity of the battery is regulated by the negative electrode, particularly in the case where charge capacity of the battery is regulated by the negative electrode, as in (7) of the present invention, the positive electrode is maintained at a relatively low potential when the battery is in normal use. A coating film is therefore relatively less likely to be formed on the positive electrode by an oxidation reaction of the components of the electrolyte solution such as the solvent, the lithium salt, and the additive contained in the non-aqueous electrolyte solution. Accordingly, the components of the electrolyte solution would be appropriately distributed to the positive electrode and the negative electrode including the titanium oxide and act on each of the positive and negative electrodes, thereby reducing reductive decomposition of the electrolyte solution on the negative electrode and sufficiently reducing generation of gas. Since the potential of the positive electrode does not become too high, oxidative decomposition of the electrolyte solution would be less likely to occur, reducing generation of gas on the positive electrode. At the same time, since the potential of the positive electrode does not become too high, degradation of the crystal structure of the positive electrode active material itself would be reduced, thereby further reducing generation of gas associated with a high temperature cycling and further reducing capacity deterioration of the battery.

In particular, it is preferable that the ratio of the negative electrode capacity to the positive electrode capacity, R=N/P, satisfy 0.7≦R<1.0, where P represents actual capacity of the positive electrode, and N represents actual capacity of the negative electrode. Even if R is smaller than 0.7, the effect of the present invention can still be obtained, but discharge capacity as the battery is reduced. The values P, N can be obtained as follows.

The positive electrode and the lithium metal foil which are shaped so as to be used in a coin cell are placed to face each other with a separator therebetween in dry argon. These members are placed in a coin cell, an electrolyte solution is introduced into the coin cell, and the coin cell is sealed with the separator and the electrode being sufficiently impregnated with the electrolyte solution. A solution of 1.0 mol/l of lithium hexafluorophosphate and 0.2 mol/l of lithium tetrafluoroborate as electrolytes in a mixed solvent of ethylene carbonate (EC), propylene carbonate (PC), and methyl ethyl carbonate (MEC) with a EC/PC/MEC volume ratio of 1:3:6 is used as the electrolyte solution. The coin cell thus produced is charged with a constant current at 0.25 C in a 25° C. environment until the cell voltage reaches 4.2 V and is then discharged with a constant current at 0.25 C in the 25° C. environment until the cell voltage reaches 3.0 V. Capacity at the time of the discharge is divided by the area of a positive electrode active material layer of the coin cell to calculate actual capacity P (mAh/cm²) in the 25° C. environment per unit area of the positive electrode. The temperature environment for measurement of the actual capacity is created by using an incubator (IN804 Incubator made by Yamato Scientific Co., Ltd.) etc.

Another coin cell is produced by a method similar to that described above except that the negative electrode shaped so as to be used in the coin cell is used instead of the positive electrode. The coin cell produced is charged with a constant current at 0.25 C in a 25° C. environment until the cell voltage reaches 1.0 V and is then discharged with a constant current at 0.25 C in the 25° C. environment until the cell voltage reaches 3.0 V. Capacity at the time of the discharge is divided by the area of a negative electrode active material layer of the coin cell to calculate actual capacity N (mAh/cm²) in the 25° C. environment per unit area of the negative electrode. In the measurement of N, charging refers to the case where lithium ions are stored in the active material, and discharging refers to the case where lithium ions are released from the active material.

A method for manufacturing a non-aqueous electrolyte secondary battery according to (12) of the present invention will be described below. This method comprises the steps of placing in a packaging member a positive electrode, a negative electrode that includes an active material containing a titanium oxide having a lithium ion storage potential of 1.2 V or higher (versus Li/Li⁺), and a non-aqueous electrolyte solution containing a lithium salt and a non-aqueous solvent that dissolves the lithium salt therein, and sealing an opening of the packaging member to produce a sealed secondary battery; and charging the sealed secondary battery. The non-aqueous solvent includes at least three solvents (a) to (c), namely (a) ethylene carbonate, (b) cyclic carboxylic acid ester, or cyclic carbonate having four or more carbon atoms, and (c) chain carbonate. The lithium salt includes at least lithium hexafluorophosphate and lithium tetrafluoroborate. The content of ethylene carbonate in the entire non-aqueous solvent is 5 to 20 vol %, and the concentration of lithium tetrafluoroborate in the non-aqueous electrolyte solution is 0.05 to 0.5 mol/l. The non-aqueous electrolyte secondary battery of the present invention is produced in this manner. This method will be described in detail below together with a method for manufacturing a non-aqueous electrolyte secondary battery comprising the step of conditioning the battery.

It is preferable that the method for manufacturing a non-aqueous electrolyte secondary battery according to the invention comprises the following step of conditioning the battery. This method comprises the steps of temporarily sealing an opening of the packaging member containing the positive electrode, the negative electrode, and the non-aqueous electrolyte solution to produce a temporarily sealed secondary battery; adjusting a negative electrode potential of the temporarily sealed secondary battery to a potential higher than 0.8 V and equal to or lower than 1.4 V (versus Li/Li⁺) and storing the temporarily sealed secondary battery in an atmosphere of 50° C. or higher and lower than 80° C.; and opening the temporarily sealed secondary battery to discharge gas therefrom, and then finally sealing the packaging member.

Adopting such conditioning in the method for manufacturing a battery comprising a negative electrode that includes an active material containing a titanium oxide and a non-aqueous electrolyte solution of the above specific composition further reduces generation of gas associated with a high temperature cycling. The mechanism of how adopting such conditioning works to further reduce generation of gas is not clear, and this mechanism does not limit the present invention, but the inventors have made the following inference. Water, carbon dioxide, etc. have been adsorbed on the surface of the titanium oxide. These impurities tend to be released as gas if the negative electrode potential is made lower than the lithium ion storage potential, i.e., if the battery is further charged even after the SOC reaches 100%. If the battery is stored at a high temperature, lithium tetrafluoroborate and ethylene carbonate are more sufficiently decomposed to form a satisfactory coating film. In the case where the non-aqueous electrolyte solution contains the dinitrile compound, the carbonate material, ethylene sulfite (ES), or 1,3-propanesultone (PS) as an additive, the additive is also easily decomposed, and together with lithium tetrafluoroborate and ethylene carbonate forms a satisfactory coating film on the titanium oxide. In particular, initially charging the battery so that the negative electrode potential becomes equal to or lower than 1.4 V (versus Li/Li⁺) and storing the battery at a high temperature facilitates desorption of the absorbed water, carbon dioxide, etc. In this state, lithium tetrafluoroborate and ethylene carbonate act on the surface of the negative electrode, or some sort of coating film is formed on the surface of the negative electrode. This further enhances the effect of the present invention, namely further reduces generation of gas. Such conditioning also facilitates consumption of lithium tetrafluoroborate and ethylene carbonate associated with formation of the coating film. This appropriately reduces the amounts of lithium tetrafluoroborate and ethylene carbonate which remain after manufacturing of the battery.

(First Step)

A temporarily sealed secondary battery is produced in the first step. An electrode group is first placed in a packaging member. The electrode group is formed by a positive electrode, a negative electrode, and a separator. Specifically, for example, a positive electrode, a separator, a negative electrode, and a separator are sequentially stacked on each other and the stack is wound into a flat shape to form a flat electrode group. In another method, for example, one or more sets of a positive electrode and a negative electrode may be stacked on each other with a separator between the positive and negative electrodes to form an electrode group. An insulating tape may be wound around the electrode group as necessary to fix the electrode group. The step of heating and/or vacuum drying the electrode group and each constituent member to reduce adsorbed water may be added after and/or before formation of the electrode group.

As shown in FIGS. 1 and 2, a belt-like positive electrode terminal 7 is electrically connected to the positive electrode 2. A belt-like negative electrode terminal 8 is electrically connected to the negative electrode 3. The positive and negative electrode terminals may be formed integrally with the positive and negative electrode current collectors, respectively. Alternatively, a terminal formed separately from the current collector may be connected to the current collector. The positive and negative electrode terminals may be respectively connected to the positive and negative electrodes before the stack is wound. Alternatively, the positive and negative electrode terminals may be respectively connected to the positive and negative electrodes after the stack is wound.

The packaging member made of a laminated film can be formed by bulging or deep drawing the laminated film from the thermoplastic resin film side to form a cup-shaped electrode group packing portion, and then bending the laminated film 180° with the thermoplastic resin film side facing inward so as to form a lid. For example, in the case where the packaging member is a metal container, the packaging member can be formed by drawing a metal sheet. An example of using the packaging member made of a laminated film will be described below as a representative example.

The electrode group is placed in the electrode group packing portion of the packaging member, and the positive and negative electrode terminals are extended to the outside of the container. Then, the upper end of the packaging member from which the positive and negative electrode terminals are extended to the outside and one of those ends of the packaging member which are perpendicular to the upper end are heat sealed to form a sealed portion. The packaging member having an opening along its one side is formed in this manner. The step of heating and/or vacuum drying each constituent member to reduce adsorbed water may be added at this time.

Subsequently, a non-aqueous electrolyte solution is introduced into the packaging member through the opening to impregnate the electrode group with the non-aqueous electrolyte solution. In order to facilitate impregnation of the electrode group with the electrolyte solution, the battery may be stored while being pressed in the thickness direction thereof, or the electrolyte solution may be introduced into the packaging member after the internal pressures of the electrodes are reduced.

Thereafter, the opening is heat sealed to form a temporarily sealed portion to produce the temporarily sealed secondary battery sealing the electrode group and the non-aqueous electrolyte solution with which the electrode group has been impregnated. In the case where conditioning is not performed, this heat sealing of the opening serves as final sealing to produce a finally sealed battery.

(Second Step)

Subsequently, a second step is performed. A current is applied between the positive and negative electrode terminals of the temporarily sealed secondary battery to initially charge the temporarily sealed secondary battery so that the negative electrode potential becomes higher than 0.8 V and equal to or lower than 1.4 V (versus Li/Li⁺). It is more preferable to initially charge the temporarily sealed secondary battery so that the negative electrode potential becomes lower than the lithium ion storage potential of the negative electrode active material by 350 mV or more.

It is preferable to initially charge the battery so that the negative electrode potential becomes equal to or lower than 1.4 V (versus Li/Li⁺) because this further reduces generation of gas associated with the use of the battery under high temperature environment and further reduces capacity deterioration of the battery. It is more preferable to initially charge the battery so that the negative electrode potential becomes equal to or lower than 1.2 V (versus Li/Li⁺). It is not preferable to initially charge the battery so that the negative electrode potential becomes equal to or lower than 0.8 V (versus Li/Li⁺). This would excessively form a coating film, reducing discharge capacity of the battery. In the case of using aluminum for the negative electrode current collector, it is not preferable to reduce the negative electrode potential to 0.4 V or less (versus Li/Li⁺) because aluminum of the current collector forms an alloy with lithium.

The period between production of the temporarily sealed secondary battery and initial charge is not particularly limited, and can be set to any period according to the production schedule etc. For example, this period may be an hour to a month. The initial charge and the high temperature storage of the battery described below are not limited to the first charge after production of the temporarily sealed secondary battery. The initial charge and the high temperature storage of the battery may be performed after the battery is charged and discharged and stored one or more times, as long as the battery can be subsequently opened to discharge gas therefrom.

For example, the negative electrode potential can be adjusted by calculating in advance such an amount of charge electricity that the negative electrode potential becomes equal to a desired potential higher than 0.8 V and equal to or lower than 1.4 V (versus Li/Li⁺) in a cell of the same battery configuration by using reference electrodes, and charging the temporarily sealed battery with the calculated amount of electricity. Alternatively, the negative electrode potential can be adjusted by charging the cell of the same battery configuration under the same conditions until the negative electrode potential becomes equal to a desired potential higher than 0.8 V and equal to or lower than 1.4 V (versus Li/Li⁺) by using the reference electrodes, checking the cell voltage at this time, and using the checked cell voltage value as an initial charge cut-off voltage for the temporarily sealed battery. Another method is as follows. A coin cell is produced by cutting out as a working electrode a positive electrode for a non-aqueous electrolyte secondary battery and using a counter electrode made of metal lithium foil and the same electrolyte solution and the same separator as those of the battery. This coin cell is charged under the same conditions of C rate and temperature as those for initial charge of the battery to obtain a charge curve with the ordinate representing the potential and the abscissa representing the capacity. For the negative electrode as well, a potential-capacity curve on the Li storage side including a desired negative electrode potential is obtained by a method according to the evaluation of the positive electrode by using as a working electrode a negative electrode cut out with the same dimensions as those for the evaluation of the positive electrode. The potential-capacity curves thus obtained for the positive and negative electrodes are superimposed on each other in a single graph. The potential of the positive electrode which corresponds to the capacity at the time the negative electrode reaches the desired negative electrode potential is read from this graph, and a cell voltage is obtained from the potential difference between the positive and negative electrodes. This cell voltage is used as an initial charge cut-off voltage.

In the case of using a lithium nickel manganese cobalt composite oxide as the positive electrode active material, it is preferable to adjust the negative electrode potential of the temporarily sealed battery so that the cell voltage becomes equal to 2.7 to 3.3 V, and more preferably 2.9 to 3.3 V. In the case of using lithium iron phosphate as the positive electrode active material, it is preferable to adjust the negative electrode potential of the temporarily sealed battery so that the cell voltage becomes equal to 2.1 to 2.7 V, and more preferably 2.3 to 2.7 V.

Although the temperature at which initial charge is carried out can be set as desired, this temperature is preferably about 20 to 45° C. and may be normal temperature (20 to 30° C.). It is preferable to carry out initial charge at normal temperature because facilities can be simplified.

A charge current value can be set as desired. When a charge current value is 1 C or less, the effect of the present invention is easily obtained. Namely, generation of gas is easily reduced under high temperature environment. It is more preferable to set the charge current value to 0.5 C or less. The current value may be changed during charging. For example, CC-CV charging may be performed. The 1 C capacity may be equal to nominal capacity of the battery.

If the temporarily sealed secondary battery has a substantially flat shape, the initial charge may be performed while pressing the battery body in the thickness direction thereof. The pressing method is not particularly limited. For example, the initial charge may be performed with the battery being pressed, or the initial charge may be performed with the battery being placed in a holder capable of fixing the battery so as to be in contact with the front and back surfaces of the battery.

Charge conditions in the step of charging the sealed secondary battery according to (12) of the present invention are not particularly limited, but the charge conditions described in (13) of the present invention are preferably used.

Thereafter, the temporarily sealed secondary battery initially charged to the above negative electrode potential is stored in an atmosphere of 50° C. or higher and lower than 80° C.

Storing the temporarily sealed secondary battery at an ambient temperature lower than 50° C. is not industrially practical as it takes time for water, carbon dioxide, etc. to be released from the electrode group. Moreover, it results in the battery with insufficient high temperature properties because an appropriate coating film would be less likely to be formed on the surface of the negative electrode. In the case of storing the temporarily sealed secondary battery at an ambient temperature equal to or higher than 80° C., the non-aqueous electrolyte tends to react at the surfaces of the positive and negative electrodes. A coating film would therefore be excessively formed, reducing discharge capacity of the battery and reducing the capacity retention to a large extent in a high temperature cycling. The ambient temperature is more preferably in the range of 50 to 70° C.

The temporarily sealed secondary battery may be stored in an atmosphere of 50° C. or higher and lower than 80° C. for any time period as long as gas is sufficiently released from the negative electrode. For example, this storage period may be 5 hours to 10 days, and preferably 1 to 8 days, although it is not limited to this. The storage period may be adjusted according to the species of the positive electrode active material. For example, in the case of using a lithium-transition metal composite oxide as the positive electrode active material, the storage period may be 5 hours to 8 days, and preferably 1 to 7 days. For example, in the case of using lithium iron phosphate as the positive electrode active material, the storage period may be 5 hours to 10 days, and preferably 5 to 8 days. The period between initial charge and the start of high temperature storage is not particularly limited, and may be set as desired.

If the temporarily sealed secondary battery is in an open circuit state during the period of high temperature storage, the negative electrode potential increase due to self-discharge. If the battery is substantially continuously charged during storage so that the battery is stored with a constant potential, the battery capacity decreases significantly after storage. It is therefore preferable not to store the battery with a constant potential. For example, it is preferable not to trickle charge or float charge the battery. In order to compensate for a part of self-discharge capacity, the battery may be intermittently charged with about 10% of the self-discharge amount during the storage. However, it is most preferable that the battery be stored in the open circuit state.

As used herein, the expression “the negative electrode potential of the temporarily sealed secondary battery is adjusted to a potential higher than 0.8 V and equal to or lower than 1.4 V, and the temporarily sealed secondary battery is stored in an atmosphere of 50° C. or higher and lower than 80° C.” does not necessarily mean that the negative electrode potential need be retained in this range during the period of high temperature storage, but includes the case where the negative electrode potential increases to a value out of this potential range during the storage period, as long as the negative electrode potential as the charge cut-off potential is in this potential range. The effect of the present invention can be obtained even in this case.

(Third Step)

Subsequently, a part of the packaging member is cut or a hole is cut in the packaging member to discharge the gas staying in the packaging member in the second step to the outside. For example, the packaging member may be opened by cutting the laminated film at any position in its opening portion that is a non-heat-sealed portion located inside the temporarily sealed portion. It is preferable to open the packaging member under a reduced pressure, and it is preferable to open the packaging member in an inert atmosphere or in dry air.

After the packaging member is opened, the non-aqueous electrolyte secondary battery may be placed under a reduced pressure atmosphere by using a reduced pressure chamber etc., or gas may be sucked from the opened part or the hole of the packaging member by using a suction nozzle. The gas in the packaging member can be more reliably discharged by these methods.

After the gas is discharged, the packaging member is heat sealed at a position inside the cut part of the opening portion to form a final sealed portion, thereby sealing the electrode group and the non-aqueous electrolyte solution again. Moreover, the packaging member is cut at a position outside the final sealed portion to cut off the opening portion. The non-aqueous electrolyte secondary battery is thus produced. At this time, it is preferable to seal the electrode group and the non-aqueous electrolyte solution under a reduced pressure. Alternatively, the electrode group and the non-aqueous electrolyte solution may be sealed by attaching an adhesive tape etc. to a region having the hole in the packaging member. Even if conditioning is not performed, the packaging member may be opened to discharge gas and may be sealed again after the step of charging the battery.

The non-aqueous electrolyte secondary battery thus produced may be charged and discharged one or more times as desired. The non-aqueous electrolyte secondary battery may further be stored at normal temperature or a high temperature. A conditioning process (the second step or the second and third steps) may be performed a plurality of times.

The present invention will be specifically described below based on examples.

### Experiment 1

### Example 1

<Production of Positive Electrode>

Powder of lithium iron phosphate (LiFePO₄) as a positive electrode active material, acetylene black, and a solution of polyvinylidene fluoride (PVdF) in N-methylpyrrolidone (NMP) are mixed so that a mass ratio of LiFePO₄:acetylene black:PVdF was 83:10:7, and NMP was added to the mixture to prepare positive electrode composite slurry. Both surfaces of a current collector made of aluminum foil and having a thickness of 20 μm was coated with the positive electrode composite slurry so that the amount of active material on each surface was 9.5 mg/cm². After the coating, the resultant coated current collector was dried and pressed to a composite density of 1.9 g/cm³ to produce a positive electrode. The positive electrode was then dried under a reduced pressure at 130° C. for 8 hours.

<Production of Negative Electrode>

Powder of lithium titanate with a spinel structure (Li₄Ti₅O₁₂, lithium storage potential: 1.55 V versus Li/Li⁺, specific surface area: 10.9 m²/g, average secondary particle size: 7.4 μm, and average primary particle size: 0.8 μm) as a negative electrode active material, acetylene black, and a solution of polyvinylidene fluoride (PVdF) in N-methylpyrrolidone (NMP) were mixed so that a mass ratio of Li₄T₅O₁₂:acetylene black:PVdF was 87.0:4.3:8.7, and NMP was added to the mixture to prepare negative electrode composite slurry. Both surfaces of a current collector made of aluminum foil and having a thickness of 20 μm was coated with this slurry so that the amount of active material on each surface was 8.0 mg/cm². After the coating, the resultant coated current collector was dried and pressed to a composite density of 1.8 to 2.0 g/cm³ to produce a negative electrode. The negative electrode was then dried under a reduced pressure at 130° C. for 8 hours. The average secondary particle size of the active material was measured by laser diffractometry (laser diffraction/scattering type particle size distribution measuring apparatus LA-950 made by HORIBA, Ltd.), and the average primary particle size thereof was obtained by electron microscopy (scanning electron microscope S-4800 made by Hitachi High-Technologies Corporation, the average of 100 primary particles). The specific surface area of the active material was measured by a single-point BET method using nitrogen adsorption by using a specific surface area measuring apparatus (Monosorb made by Quantachrome Instruments).

<Production of Electrode Group>

The sheet-like positive electrode, a separator made of rayon and having a thickness of 50 μm, the sheet-like negative electrode produced as described above, and another separator were sequentially stacked on each other in this order, and the stack was fixed with an insulating tape. After the stack was fixed, a lead tab made of aluminum foil and having a thickness of 20 μm was welded to the current collectors of the positive and negative electrodes. An electrode group thus produced was a flat electrode group having a width of 36 mm and a thickness of 3.9 mm.

<Preparation of Non-Aqueous Electrolyte>

0.5 mol/l of lithium hexafluorophosphate (LiPF₆) and 0.2 mol/l of lithium tetrafluoroborate (LiBF₄) as lithium salts were dissolved in a mixed solvent of the solvents (a) to (c), namely (a) ethylene carbonate (EC), (b) propylene carbonate (PC), and (c) methyl ethyl carbonate (MEC) (EC/PC/MEC volume ratio of 5:35:60) to prepare a non-aqueous electrolyte solution. The solution thus prepared will be referred to as the electrolyte solution A.

<First Step>

As a first step, the electrode group produced as described above was placed in a packaging member made of a laminated film so that the positive and negative electrode terminals were extended to the outside from one side of the packaging member. The resultant packaging member was vacuum dried at 80° C. for 8 hours. The non-aqueous electrolyte solution A was introduced into the packaging member to impregnate the electrode group with the non-aqueous electrolyte solution A. An opening of the laminated film was then temporarily sealed by heat sealing to produce a temporarily sealed secondary battery.

Actual capacity P of the positive electrode and actual capacity N of the negative electrode used in this temporarily sealed secondary battery were measured by the method described above. P was 1.42 mAh/cm² and N was 1.33 mAh/cm². In this temporarily sealed secondary battery, the ratio of the negative electrode capacity to the positive electrode capacity, R=N/P, is therefore 0.94, and designed capacity is 460 mAh.

<Second Step>

As a second step, the temporarily sealed secondary battery was sandwiched between two holding plates and fixed with a clip. The temporarily sealed secondary battery was thus pressed and left in this state for 3 hours. Thereafter, a current was applied between the positive and negative electrode terminals to charge the temporarily sealed secondary battery at 0.25 C (115 mA) at normal temperature (25° C.) until the negative electrode potential reached 1.0 V. A cell voltage at this time was 2.5 V.

Subsequently, the initially charged temporarily sealed secondary battery was stored in an open circuit state for 168 hours in a 55° C. atmosphere (incubator).

As a third step, the temporarily sealed secondary battery stored was cooled to an ambient temperature, a part of the laminated film was cut off, and the resultant temporarily sealed secondary battery was placed in a reduced pressure chamber to discharge gas. Thereafter, the cut part of the laminated film was sealed again (finally sealed) by heat sealing. The temporarily sealed secondary battery was assembled and conditioned in this manner to produce a non-aqueous electrolyte secondary battery of Example 1 having a width of 60 mm, a thickness of 3.9 mm, and a height of 83 mm.

### Examples 2 to 27 and Comparative Examples 1 to 18

Non-aqueous electrolyte secondary batteries of Examples 2 to 27 and Comparative Examples 1 to 18 were produced by a method similar to that of Example 1 except that non-aqueous electrolyte solutions B to AA, AB to AS shown in Tables 1 and 2 were used as a non-aqueous electrolyte. In Table 1, the concentration of lithium hexafluorophosphate (LiPF₆) in the electrolyte solution is shown by x mol/l, the concentration of lithium tetrafluoroborate (LiBF₄) in the electrolyte solution is shown by y mol/l, the concentration of the solvent (a), namely ethylene carbonate (EC), in the entire solvent is shown by a vol %, the concentration of the solvent (b), namely propylene carbonate (PC), in the entire solvent is shown by b vol %, and the concentration of the solvent (c), namely methyl ethyl carbonate (MEC), in the entire solvent is shown by c vol %, where a+b+c=100 vol %.

In Example 12, b vol % of γ-butyrolactone was used as the solvent (b) instead of propylene carbonate. In Example 13, c vol % of diethyl carbonate was used as the solvent (c) instead of methyl ethyl carbonate. As an additive, 2 mass % of vinylene carbonate (VC) was added to the electrolyte solution in Example 21, 2 mass % of succinonitrile (SCN) was added to the electrolyte solution in Example 22, 2 mass % of ethylene sulfite (ES) was added to the electrolyte solution in Example 23, and 2 mass % of 1,3-propanesultone (PS) was added to the electrolyte solution in Example 24.

TABLE 1

| | Electrolyte | | | | | | |
|---|---|---|---|---|---|---|---|
| | Solution | x | y | a | b | c | Additive |
| Example 1 | A | 0.5 | 0.2 | 5 | 35 | 60 | — |
| Example 2 | B | 0.5 | 0.5 | 5 | 35 | 60 | — |
| Example 3 | C | 0.5 | 0.2 | 10 | 30 | 60 | — |
| Example 4 | D | 0.5 | 0.5 | 10 | 30 | 60 | — |
| Example 5 | E | 0.5 | 0.2 | 20 | 20 | 60 | — |
| Example 6 | F | 0.5 | 0.5 | 20 | 20 | 60 | — |
| Example 7 | G | 1.0 | 0.05 | 5 | 35 | 60 | — |
| Example 8 | H | 1.0 | 0.2 | 5 | 35 | 60 | — |
| Example 9 | I | 1.0 | 0.5 | 5 | 35 | 60 | — |
| Example 10 | J | 1.0 | 0.05 | 10 | 30 | 60 | — |
| Example 11 | K | 1.0 | 0.2 | 10 | 30 | 60 | — |
| Example 12 | L | 1.0 | 0.2 | 10 | 30 | 60 | — |
| Example 13 | M | 1.0 | 0.2 | 10 | 30 | 60 | — |
| Example 14 | N | 1.0 | 0.5 | 10 | 30 | 60 | — |
| Example 15 | O | 1.0 | 0.05 | 20 | 20 | 60 | — |
| Example 16 | P | 1.0 | 0.2 | 20 | 20 | 60 | — |
| Example 17 | Q | 1.0 | 0.5 | 20 | 20 | 60 | — |
| Example 18 | R | 1.4 | 0.05 | 5 | 35 | 60 | — |
| Example 19 | S | 1.4 | 0.05 | 10 | 30 | 60 | — |
| Example 20 | T | 1.4 | 0.05 | 20 | 20 | 60 | — |
| Example 21 | U | 1.0 | 0.2 | 10 | 30 | 60 | VC |
| Example 22 | V | 1.0 | 0.2 | 10 | 30 | 60 | SCN |
| Example 23 | W | 1.0 | 0.2 | 10 | 30 | 60 | ES |
| Example 24 | X | 1.0 | 0.2 | 10 | 30 | 60 | PS |
| Example 25 | Y | 1.2 | 0.5 | 10 | 30 | 60 | — |
| Example 26 | Z | 1.0 | 0.2 | 20 | 40 | 40 | — |
| Example 27 | AA | 1.0 | 0.2 | 20 | 10 | 70 | — |

TABLE 2

| | Electrolyte | | | | | | |
|---|---|---|---|---|---|---|---|
| | Solution | x | y | a | b | c | Additive |
| Comparative | AB | 0.5 | 0.2 | 30 | 10 | 60 | — |
| Example 1 | | | | | | | |
| Comparative | AC | 0.5 | 0.5 | 30 | 10 | 60 | — |
| Example 2 | | | | | | | |
| Comparative | AD | 1.0 | 0.05 | 30 | 10 | 60 | — |
| Example 3 | | | | | | | |
| Comparative | AE | 1.0 | 0.2 | 30 | 10 | 60 | — |
| Example 4 | | | | | | | |
| Comparative | AF | 1.0 | 0.5 | 30 | 10 | 60 | — |
| Example 5 | | | | | | | |
| Comparative | AG | 1.4 | 0.05 | 30 | 10 | 60 | — |
| Example 6 | | | | | | | |
| Comparative | AH | 0.5 | 0.7 | 5 | 35 | 60 | — |
| Example 7 | | | | | | | |
| Comparative | AI | 0.5 | 0.7 | 10 | 30 | 60 | — |
| Example 8 | | | | | | | |
| Comparative | AJ | 0.5 | 0.7 | 20 | 20 | 60 | — |
| Example 9 | | | | | | | |
| Comparative | AK | 0.5 | 0.7 | 30 | 10 | 60 | — |
| Example 10 | | | | | | | |
| Comparative | AL | 1.0 | 0.2 | 50 | 50 | 0 | — |
| Example 11 | | | | | | | |
| Comparative | AM | 1.0 | 0.2 | 40 | 0 | 60 | — |
| Example 12 | | | | | | | |
| Comparative | AN | 0 | 1.0 | 10 | 30 | 60 | — |
| Example 13 | | | | | | | |
| Comparative | AO | 1.0 | 0.2 | 0 | 40 | 60 | — |
| Example 14 | | | | | | | |
| Comparative | AP | 1.0 | 0 | 10 | 30 | 60 | — |
| Example 15 | | | | | | | |
| Comparative | AQ | 1.0 | 0.2 | 100 | 0 | 0 | — |
| Example 16 | | | | | | | |
| Comparative | AR | 1.0 | 0.2 | 0 | 100 | 0 | — |
| Example 17 | | | | | | | |
| Comparative | AS | 1.0 | 0.2 | 0 | 0 | 100 | — |
| Example 18 | | | | | | | |

<Measurement>

The following measurement was carried out for the non-aqueous electrolyte secondary batteries of Examples 1 to 27 and Comparative Examples 1 to 18 produced as described above.

<Measurement of Discharge Capacity>

The non-aqueous electrolyte secondary battery was stored in an incubator of 25° C. to stabilize the temperature of the battery. Then, the non-aqueous electrolyte secondary battery was discharged to SOC of 0% (1 C, cut-off voltage: 1.0V). The non-aqueous electrolyte secondary battery was rested for 30 minutes, and then was charged with a constant current at 1 C to 2.5 V. The non-aqueous electrolyte secondary battery was rested for 30 minutes, and then was discharged at 1 C to 1.0 V. The capacity at this time is defined as the discharge capacity. The discharge capacity was measured after conditioning under these conditions. The discharge capacity thus measured is defined as the initial capacity.

<High Temperature Cycle Test>

The non-aqueous electrolyte secondary battery was placed in the incubator of 55° C. and was charged and discharged 500 cycles under the same charge and discharge conditions as those for the measurement of the capacity (charge: 1 C, cut-off voltage of 2.5 V, rest: 30 minutes, discharge: 1 C, cut-off voltage of 1.0 V, and rest: 30 minutes). After the 500 cycles, the measurement of the discharge capacity was carried out again to obtain the capacity after the cycles, and the discharge capacity retention (=capacity after the cycles/initial capacity) was calculated. The result is shown in Tables 3, 4.

<Measurement of Amount of Gas>

The non-aqueous electrolyte secondary battery was placed in a graduated cylinder containing 500 ml of water to measure the volume of the battery. The volume of the battery was measured after the measurement of the initial capacity and after the 500 cycles of the high temperature cycle test. The amount of change in volume is defined as the amount of gas generated. The result is also shown in Tables 3, 4.

TABLE 3

| | Amount of Gas | Discharge Capac- |
|---|---|---|
| | Generated | ity Retention |
| | (ml) | (%) |
| Example 1 | 1.5 | 94 |
| Example 2 | 1.0 | 92 |
| Example 3 | 1.3 | 93 |
| Example 4 | 0.8 | 94 |
| Example 5 | 1.0 | 92 |
| Example 6 | 0.6 | 93 |
| Example 7 | 1.2 | 94 |
| Example 8 | 0.6 | 93 |
| Example 9 | 0.5 | 94 |
| Example 10 | 1.2 | 93 |
| Example 11 | 0.8 | 91 |
| Example 12 | 0.5 | 90 |
| Example 13 | 0.9 | 93 |
| Example 14 | 0.4 | 96 |
| Example 15 | 0.9 | 95 |
| Example 16 | 0.2 | 93 |
| Example 17 | 0.3 | 95 |
| Example 18 | 1.0 | 93 |
| Example 19 | 0.7 | 92 |
| Example 20 | 0.5 | 95 |
| Example 21 | 0.2 | 98 |
| Example 22 | 0.3 | 97 |
| Example 23 | 0.3 | 96 |
| Example 24 | 0.4 | 95 |
| Example 25 | 0.3 | 90 |
| Example 26 | 0.4 | 92 |
| Example 27 | 0.4 | 93 |

TABLE 4

| | Amount of Gas | Discharge Capac- |
|---|---|---|
| | Generated | ity Retention |
| | (ml) | (%) |
| Comparative | 0.7 | 94 |
| Example 1 | | |
| Comparative | 0.6 | 90 |
| Example 2 | | |
| Comparative | 0.7 | 93 |
| Example 3 | | |
| Comparative | 0.4 | 92 |
| Example 4 | | |
| Comparative | 0.4 | 92 |
| Example 5 | | |
| Comparative | 0.7 | 94 |
| Example 6 | | |
| Comparative | 0.4 | 82 |
| Example 7 | | |
| Comparative | 0.3 | 85 |
| Example 8 | | |
| Comparative | 0.3 | 81 |
| Example 9 | | |
| Comparative | 0.2 | 82 |
| Example 10 | | |
| Comparative | 0.4 | 93 |
| Example 11 | | |
| Comparative | 0.5 | 94 |
| Example 12 | | |
| Comparative | 0.3 | 84 |
| Example 13 | | |
| Comparative | 3.1 | 89 |
| Example 14 | | |
| Comparative | 3.7 | 92 |
| Example 15 | | |
| Comparative | — | — |
| Example 16 | | |
| Comparative | 3.5 | 78 |
| Example 17 | | |
| Comparative | 3.8 | 73 |
| Example 18 | | |

As can be seen from Tables 3, 4, in Comparative Example 14 that does not contain ethylene carbonate, Comparative Example 15 that does not contain lithium tetrafluoroborate, Comparative Example 17 that does not contain ethylene carbonate and chain carbonate, and Comparative Example 18 that does not contain ethylene carbonate and cyclic carbonate, more than 3 milliliters of gas was generated. Comparative Example 16 did not function as a battery. In Examples and the other Comparative Examples, the amount of gas generated was 1.5 milliliters or less, which means that generation of gas was significantly reduced. In each Example, the discharge capacity retention after the 500 cycles was 90% or more. It can be seen from this high discharge capacity retention and the reduced generation of gas that each Example has excellent high temperature cycle properties. In Comparative Examples 7 to 10 and 13 that contain more than 0.5 mol/l of lithium tetrafluoroborate, generation of gas was reduced, but the discharge capacity retention after the 500 cycles was less than 90%, and capacity deterioration tended to occur more quickly.

### Experiment 2

### Example 28

<Production of Positive Electrode>

Powder of a lithium nickel manganese cobalt composite oxide (LiNi_{1/3}Mn_{1/3}Co_{1/3}O₂) as a positive electrode active material, acetylene black, and a solution of polyvinylidene fluoride (PVdF) in N-methylpyrrolidone (NMP) were mixed so that a mass ratio of LiNi_{1/3}Mn_{1/3}Co_{1/3}O₂:acetylene black:PVdF was 92:4:4, and NMP was added to the mixture to prepare positive electrode composite slurry. Both surfaces of a current collector made of aluminum foil and having a thickness of 20 μm was coated with the positive electrode composite slurry so that the amount of active material on each surface was 9.8 mg/cm². After the coating, the resultant coated current collector was dried and pressed to a composite density of 2.5 g/cm³ to produce a positive electrode. The positive electrode was then dried under a reduced pressure at 130° C. for 8 hours.

A non-aqueous electrolyte secondary battery of Example 28 was produced by a method similar to that of Example 1 except that the positive electrode produced by the above process using the lithium nickel manganese cobalt composite oxide as an active material and the electrolyte solution K were used, that the designed capacity was 400 mAh in <First Step>, and that the battery was charged at 0.25 C (100 mA), the charge voltage was 3.1 V (the negative electrode potential at this time was 1.0 V), and the discharge voltage was 1.4 V in <Second Step>.

### Comparative Example 19

A non-aqueous electrolyte secondary battery of Comparative Example 19 was produced by a method similar to that of Example 28 except that the electrolyte solution AO was used.

### Comparative Example 20

A non-aqueous electrolyte secondary battery of Comparative Example 20 was produced by a method similar to that of Example 28 except that the electrolyte solution AP was used.

<Measurement>

The following measurement was carried out for the non-aqueous electrolyte secondary batteries of Example 28 and Comparative Examples 19, 20 produced as described above.

<Measurement of Discharge Capacity>

The non-aqueous electrolyte secondary battery was stored in an incubator of 25° C. to stabilize the temperature of the battery. Then, the non-aqueous electrolyte secondary battery was discharged to SOC of 0% (1 C, cut-off voltage: 1.4 V). The non-aqueous electrolyte secondary battery was rested for 30 minutes, and then was charged with a constant current at 1 C to 3.1 V. The non-aqueous electrolyte secondary battery was rested for 30 minutes, and then was discharged at 1 C to 1.4 V. The capacity at this time is defined as the discharge capacity. The discharge capacity was measured after conditioning under these conditions. The discharge capacity thus measured is defined as the initial capacity.

<High Temperature Cycle Test>

The non-aqueous electrolyte secondary battery was placed in the incubator of 55° C. and was charged and discharged 500 cycles under the same charge and discharge conditions as those for the measurement of the capacity (charge: 1 C, cut-off voltage: 3.1 V, rest: 30 minutes, discharge: 1 C, cut-off voltage: 1.4 V, and rest: 30 minutes). After the 500 cycles, the measurement of the discharge capacity was carried out again to obtain the capacity after the cycles, and the discharge capacity retention (=capacity after the cycles/initial capacity) was calculated. The result is shown in Table 5.

<Measurement of Amount of Gas>

Measurement was performed by a method similar to that of Experiment 1. The result is also shown in Table 5.

TABLE 5

| | | Amount of Gas | Discharge Capac- |
|---|---|---|---|
| | Electrolyte | Generated | ity Retention |
| | Solution | (ml) | (%) |
| Example 28 | K | 1.0 | 92 |
| Comparative | AO | 3.5 | 83 |
| Example 19 | | | |
| Comparative | AP | 4.0 | 88 |
| Example 20 | | | |

In Example 28, generation of gas was reduced and the discharge capacity retention was high because of the use of an electrolyte solution containing appropriate amounts of ethylene carbonate and lithium tetrafluoroborate. Comparative Example 19 is an example using an electrolyte solution that does not contain ethylene carbonate, and Comparative Example 20 is an example using an electrolyte solution that does not contain lithium tetrafluoroborate. In both Comparative Examples 19, 20, a large amount of gas was generated as compared to Example 28. Moreover, in both Comparative Examples 19, 20, the discharge capacity retention after the 500 cycles was less than 90%, and the capacity deterioration tended to occur more quickly. As can be seen from comparison between Tables 3 and 5, the batteries using a lithium nickel manganese cobalt composite oxide as a positive electrode active material also exhibited properties having the same tendency as that of Experiment 1 using lithium iron phosphate (LiFePO₄) as a positive electrode active material. Similar effects are expected to be obtained even when other kinds of positive electrode active materials are used.

### Experiment 3

### Example 29

<Production of Working Electrode>Powder of lithium titanate with a spinel structure as an active material was mixed with acetylene black as a conductive material. The lithium titanate used was the same as that used in Experiment 1. Then, a solution of polyvinylidene fluoride (PVdF) in N-methylpyrrolidone (NMP) was added to the mixture and mixed together. NMP was added to the mixed solution, and the resultant solution was stirred at 2,000 rpm for 3 minutes and defoamed at 2,200 rpm for 30 seconds with a stirring/defoaming apparatus (THINKY MIXER made by THINKY CORPORATION). The defoaming was performed twice. Thereafter, the resultant solution was stirred at 2,000 rpm for 5 minutes and defoamed at 2,200 rpm for 30 seconds. This time, the defoaming was performed only once. Composite slurry was prepared in this manner. The mass ratio of Li₄Ti₅O₁₂:acetylene black:PVdF was 89.3:4.5:6.2. Thereafter, one surface of a current collector made of aluminum foil and having a thickness of 20 μm was coated with the prepared composite slurry so that the amount of active material on the surface was 3.0 mg/cm². The resultant coated current collector was dried and then pressed to a composite density of 1.8 to 2.0 g/cm³, and the electrode material was cut into a circular shape with a diameter of 12 mm to produce a working electrode. The working electrode was then dried under a reduced pressure at 130° C. for 8 hours.

<Preparation of Non-Aqueous Electrolyte Solution>

The electrolyte solution A in Table 1 was used.

<Production of Evaluation Cell>

This working electrode was incorporated in a sealable coin type evaluation cell in a glove box with a dew point of −70° C. or lower. The evaluation cell used was made of stainless steel (SUS316) and had an outer diameter of 20 mm and a height of 3.2 mm. A counter electrode used (which also served as a reference electrode) was obtained by forming metal lithium foil having a thickness of 0.5 mm into a circle having a diameter of 12 mm. The working electrode produced as described above was placed in a lower case of the evaluation cell, and a microporous polypropylene film having a thickness of 20 μm and the metal lithium foil were sequentially stacked thereon in this order so that a composite layer of the working electrode faces the metal lithium foil with a separator therebetween. Thereafter, a non-aqueous electrolyte solution was dropped thereon so that the electrode group was impregnated with the non-aqueous electrolyte solution. A 0.5 mm-thick spacer for thickness adjustment and a spring (both made of SUS316) were placed thereon. An upper case having a gasket made of polypropylene was placed thereon, and the outer peripheral edges of the upper and lower cases were crimped to seal the evaluation cell. The evaluation cell was thus assembled. Designed capacity was 0.497 mAh.

The cell thus assembled was left for 3 hours. A current was then applied between a working electrode terminal and a counter electrode terminal of the cell at 0.25 C (0.124 mA) to charge the cell at 25° C. until the cell voltage reached 1 V. Thereafter, a current was applied at 0.25 C (0.124 mA) to discharge the cell at 25° C. until the cell voltage reached 3 V. This charge and discharge process was performed twice, and the resultant cell was used as the evaluation cell. In Experiment 3, charging refers to the case where lithium ions are stored in lithium titanate.

### Examples 30 to 55

### Comparative Examples 21 to 38

Evaluation cells of Examples 30 to 55 and Comparative Examples 21 to 38 were produced by a method similar to that of Example 29 except that the electrolyte solutions B to AA, AB to AS shown in Tables 1, 2 were used as a non-aqueous electrolyte solution instead of the electrolyte solution A.

<Evaluation of Low-Temperature Charge and Discharge Properties>

Discharge capacity at 25° C. is obtained for the evaluation cells of Examples 29 to 55 and Comparative Examples 21 to 38 produced by the above procedures. Specifically, the evaluation cell was charged with a constant current at 0.5 C (0.248 mA) to 1 V, was rested for 30 minutes, and then was discharged with a constant current at 0.5 C (0.248 mA) to 3 V. Discharge capacity at this time is defined as the 25° C. capacity. Next, discharge capacity at the measurement temperature of −40° C. is obtained. The evaluation cell was placed in an incubator of −40° C. and held therein for 6 hours. Thereafter, the evaluation cell was charged with a constant current at 0.5 C (0.248 mA) to 1 V, was rested for 30 minutes, and then was discharged with a constant current at 0.5 C to 3 V. Discharge capacity at this time is defined as the −40° C. capacity. Capacity retention, namely −40° C. capacity/25° C. capacity, was calculated. The result is shown in Tables 6, 7.

TABLE 6

| | Electrolyte | Capacity Retention |
|---|---|---|
| | Solution | (%) |
| Example 29 | A | 51 |
| Example 30 | B | 50 |
| Example 31 | C | 48 |
| Example 32 | D | 47 |
| Example 33 | E | 47 |
| Example 34 | F | 46 |
| Example 35 | G | 58 |
| Example 36 | H | 55 |
| Example 37 | I | 51 |
| Example 38 | J | 59 |
| Example 39 | K | 57 |
| Example 40 | L | 54 |
| Example 41 | M | 56 |
| Example 42 | N | 49 |
| Example 43 | O | 51 |
| Example 44 | P | 48 |
| Example 45 | Q | 47 |
| Example 46 | R | 56 |
| Example 47 | S | 54 |
| Example 48 | T | 50 |
| Example 49 | U | 56 |
| Example 50 | V | 55 |
| Example 51 | W | 54 |
| Example 52 | X | 54 |
| Example 53 | Y | 44 |
| Example 54 | Z | 42 |
| Example 55 | AA | 40 |

TABLE 7

| | Electrolyte | Capacity Retention |
|---|---|---|
| | Solution | (%) |
| Comparative | AB | 34 |
| Example 21 | | |
| Comparative | AC | 32 |
| Example 22 | | |
| Comparative | AD | 35 |
| Example 23 | | |
| Comparative | AE | 34 |
| Example 24 | | |
| Comparative | AF | 30 |
| Example 25 | | |
| Comparative | AG | 29 |
| Example 26 | | |
| Comparative | AH | 33 |
| Example 27 | | |
| Comparative | AI | 32 |
| Example 28 | | |
| Comparative | AJ | 31 |
| Example 29 | | |
| Comparative | AK | 28 |
| Example 30 | | |
| Comparative | AL | 20 |
| Example 31 | | |
| Comparative | AM | 14 |
| Example 32 | | |
| Comparative | AN | 26 |
| Example 33 | | |
| Comparative | AO | 53 |
| Example 34 | | |
| Comparative | AP | 52 |
| Example 35 | | |
| Comparative | AQ | — |
| Example 36 | | |
| Comparative | AR | 18 |
| Example 37 | | |
| Comparative | AS | 25 |
| Example 38 | | |

Each of Examples 29 to 55 had capacity retention of 40% or higher, which shows that Examples 29 to 55 have excellent low-temperature properties. In Comparative Examples 21 to 26, 30 to 32 in which the content of ethylene carbonate is higher than 20 vol %, and Comparative Examples 27 to 30, 33 in which the concentration of lithium tetrafluoroborate is higher than 0.5 mol/l, the capacity retention was less than 35%. This shows that Comparative Examples 21 to 33 have poor discharge properties at −40° C. as compared to Examples 29 to 55. In Comparative Examples 34, 35, the capacity retention was high, but a significant amount of gas was generated in a high temperature cycling, as shown in Experiment 1. This shows that Comparative Examples 34, 35 have excellent low-temperature properties, but do not have enough high-temperature properties. Comparative Example 36 did not function as a battery.

The results of Experiments 1 to 3 show that the electrolyte solution of the present invention is preferred in order to reduce generation of gas and reduction in capacity retention in a high temperature cycling and, at the same time, to achieve excellent low-temperature charge and discharge properties, in the case of using a high potential titanium oxide as a negative electrode active material.

In particular, the use of the electrolyte solutions A to Z in which the content “a” of (a) ethylene carbonate and the content “b” of (b) cyclic carboxylic acid ester or cyclic carbonate having four or more carbon atoms satisfy b≧a improves the low-temperature charge and discharge properties.

Moreover, the use of the electrolyte solutions A to Y in which the content “c” (vol %) of (c) chain carbonate and the contents “a,” “b” satisfy (a+b)≦c further improves the low-temperature charge and discharge properties.

In particular, the use of the electrolyte solutions G, H, J, K, R, S in which the content “a” of ethylene carbonate is 5 to 10 vol % and the concentration of lithium tetrafluoroborate is 0.05 to 0.3 mol/l greatly achieves both excellent capacity retention in a high temperature cycling and excellent low-temperature charge and discharge properties.

The use of the electrolyte solutions S to V containing VC, SCN, ES, or PS as an additive further reduces generation of gas in a high temperature cycling.

Although some embodiments of the present invention are described above, these embodiments are shown by way of example only and are not intended to limit the scope of the invention. These novel embodiments can be carried out in various other forms, various eliminations, substitutions, and modifications can be made without departing from the spirit and scope of the invention. These embodiments and modifications thereof are included in the spirit and scope of the invention and included in the invention described in claims and in the scope equivalent thereto.

### INDUSTRIAL APPLICABILITY

A non-aqueous electrolyte secondary battery that reduces generation of gas associated with a high temperature cycling and reduces capacity deterioration of the battery and that has excellent low-temperature charge and discharge properties is provided according to the present invention. The non-aqueous electrolyte secondary battery of the present invention can therefore be used for various known applications. Specific examples of the applications include a notebook computer, a pen input computer, a mobile computer, an electronic book player, a mobile phone, mobile fax machine, a mobile copier, a mobile printer, a headphone stereo player, a camcorder, a liquid crystal display television, a portable cleaner, a portable CD player, a MiniDisc player, a handheld transceiver, an electronic organizer, a calculator, a memory card, a portable cassette tape recorder, a radio, a backup power supply, a motor, a car, a motorbike, a moped, a bicycle, a lighting apparatus, a toy, a game system, a clock, a power tool, an electronic flash, a camera, a power source for load leveling, and a power source for natural energy storage.

### REFERENCE SIGNS LIST

1 Non-Aqueous Electrolyte Secondary Battery
2 Positive Electrode
2a Positive Electrode Current Collector
2b Positive Electrode Active Material Layer
3 Negative Electrode
3a Negative Electrode Current Collector
3b Negative Electrode Active Material Layer
4 Separator
5 Non-Aqueous Electrolyte Solution
6 Packaging Member
7 Positive Electrode Terminal
8 Negative Electrode Terminal

1. A non-aqueous electrolyte secondary battery comprising a positive electrode, a negative electrode that includes an active material containing a titanium oxide having a lithium ion storage potential of 1.2 V or higher (versus Li/Li⁺), and a non-aqueous electrolyte solution containing a lithium salt and a non-aqueous solvent that dissolves said lithium salt therein, wherein
said non-aqueous solvent includes at least three solvents (a) to (c), namely (a) ethylene carbonate, (b) cyclic carboxylic acid ester, or cyclic carbonate having four or more carbon atoms, and (c) chain carbonate,
said lithium salt includes at least lithium hexafluorophosphate and lithium tetrafluoroborate,
a content of said ethylene carbonate in the entire non-aqueous solvent is 5 to 20 vol %, and
a concentration of said lithium tetrafluoroborate in said non-aqueous electrolyte solution is 0.05 to 0.5 mol/l.

2. The non-aqueous electrolyte secondary battery according to claim 1, wherein
a content “a” (vol %) of said solvent (a) in said non-aqueous solvent and a content “b” (vol %) of said solvent (b) in said non-aqueous solvent satisfy b≧a.

3. The non-aqueous electrolyte secondary battery according to claim 1, wherein
said contents “a,” “b” and a content “c” (vol %) of said solvent (c) in said non-aqueous solvent satisfy (a+b)≦c.

4. The non-aqueous electrolyte secondary battery according to claim 1, wherein
a molar concentration of said lithium hexafluorophosphate in said non-aqueous electrolyte solution is 0.5 to 1.4 mol/l.

5. The non-aqueous electrolyte secondary battery according to claim 1, wherein
said solvent (b) includes cyclic carbonate or cyclic carboxylic acid ester having a melting point of −30° C. or less and a dielectric constant of 30 or more, and said solvent (c) includes chain carbonate having a melting point of −40° C. or less.

6. The non-aqueous electrolyte secondary battery according to claim 1, wherein
said solvent (b) includes at least one selected from propylene carbonate, butylene carbonate, pentylene carbonate, γ-butyrolactone, and γ-valerolactone, and said solvent (c) includes at least one selected from ethyl methyl carbonate and diethyl carbonate.

7. The non-aqueous electrolyte secondary battery according to claim 1, wherein
charge capacity of said non-aqueous electrolyte secondary battery is regulated by said negative electrode.

8. The non-aqueous electrolyte secondary battery according to claim 1, wherein
said titanium oxide is at least one selected from lithium titanate with a spinel structure, lithium titanate with a ramsdellite structure, a monoclinic titanic acid compound, a monoclinic titanium oxide, and lithium hydrogen titanate.

9. The non-aqueous electrolyte secondary battery according to claim 1, wherein
said titanium oxide is at least one selected from Li₄₊ₓTi₅O₁₂, Li₂₊ₓTi₃O₇, a titanic acid compound given by a general formula H₂TiₙO₂ₙ₊₁, and a bronze titanium oxide (where x is a real number that satisfies 0≦x≦3 and n is an even number of 4 or more).

10. The non-aqueous electrolyte secondary battery according to claim 1, wherein
said non-aqueous electrolyte solution further contains at least one selected from a dinitrile compound, vinylene carbonate, ethylene sulfite, and 1,3-propanesultone.

11. The non-aqueous electrolyte secondary battery according to claim 1, wherein
an active material of said positive electrode is lithium iron phosphate.

12. A method for manufacturing a non-aqueous electrolyte secondary battery, comprising the steps of:
placing in a packaging member a positive electrode, a negative electrode that includes an active material containing a titanium oxide having a lithium ion storage potential of 1.2 V or higher (versus Li/Li⁺), and a non-aqueous electrolyte solution containing a lithium salt and a non-aqueous solvent that dissolves said lithium salt therein, and sealing an opening of said packaging member to produce a sealed secondary battery; and
charging said sealed secondary battery, wherein
said non-aqueous solvent includes at least three solvents (a) to (c), namely (a) ethylene carbonate, (b) cyclic carboxylic acid ester, or cyclic carbonate having four or more carbon atoms, and (c) chain carbonate,
said lithium salt includes at least lithium hexafluorophosphate and lithium tetrafluoroborate,
a content of said ethylene carbonate in the entire non-aqueous solvent is 5 to 20 vol %, and
a concentration of said lithium tetrafluoroborate in said non-aqueous electrolyte solution is 0.05 to 0.5 mol/l.

13. A method for manufacturing a non-aqueous electrolyte secondary battery, comprising the steps of:
placing in a packaging member a positive electrode, a negative electrode that includes an active material containing a titanium oxide having a lithium ion storage potential of 1.2 V or higher (versus Li/Li⁺), and a non-aqueous electrolyte solution containing a lithium salt and a non-aqueous solvent that dissolves said lithium salt therein, and temporarily sealing an opening of said packaging member to produce a temporarily sealed secondary battery;
adjusting a negative electrode potential of said temporarily sealed secondary battery to a potential higher than 0.8 V and equal to or lower than 1.4 V (versus Li/Li⁺) and storing said temporarily sealed secondary battery in an atmosphere of 50° C. or higher and lower than 80° C.; and
opening said temporarily sealed secondary battery to discharge gas therefrom, and then finally sealing said packaging member, wherein
said non-aqueous solvent includes at least three solvents (a) to (c), namely (a) ethylene carbonate, (b) cyclic carboxylic acid ester, or cyclic carbonate having four or more carbon atoms, and (c) chain carbonate,
said lithium salt includes at least lithium hexafluorophosphate and lithium tetrafluoroborate,
a content of said ethylene carbonate in the entire non-aqueous solvent is 5 to 20 vol %, and
a concentration of said lithium tetrafluoroborate in said non-aqueous electrolyte solution is 0.05 to 0.5 mol/l.

14. The method according to claim 13, wherein
said storage of said temporarily sealed secondary battery is performed in an open circuit.
